(19) United States
(12) Patent Application Publication
(10) Pub. No.: US 2026/0019866 A1
(43) Pub. Date: Jan. 15, 2026

(54) METHODS AND APPARATUSES FOR PERFORMING UPLINK (UL) DATA PREDICTION AND REPORTING PREDICTED UL BUFFER STATUS

(71) Applicant: InterDigital Patent Holdings, Inc., Wilmington, DE (US)

(72) Inventors: Oumer Teyeb, Montreal (CA); Yugeswar Deenoo Narayanan Thangaraj, Chalfont, PA (US); Filipe Conceicao, London (GB); Tezcan Cogalan, London (GB); James Miller, Northport, NY (US)

(73) Assignee: InterDigital Patent Holdings, Inc., Wilmington, DE (US)

(21) Appl. No.: 18/880,996

(22) PCT Filed: Jul. 10, 2023
(86) PCT No.: PCT/US2023/027214

§ 371 Date: Jan. 3, 2025

Related U.S. Application Data
(60) Provisional application No. 63/388,055, filed on Jul. 11, 2022.
(60) Provisional application No. 63/410,924, filed on Sep. 28, 2022.

(51) Int. Cl. H04W 28/02

(52) U.S. Cl. CPC H04W 28/0278

(57) ABSTRACT

A wireless transmit/receive unit (WTRU) may receive predictive buffer status report (BSR) configuration information. The predictive BSR configuration information may include information indicating an associated time frame and at least one triggering condition. The WTRU may predict an amount of uplink (UL) traffic corresponding to the associated time frame. The WTRU may predict BSR configuration information. The WTRU may determine that at least one triggering conditions has been met. The WTRU may send a predictive BSR, the predictive BSR comprising an indication of the predicted amount of UL traffic.

### CROSS REFERENCE TO RELATED APPLICATIONS

This application claims priority to U.S. Provisional Patent Application No. 63/388,055, filed Jul. 11, 2022, and U.S. Provisional Patent Application No. 63/410,924, filed Sep. 28, 2022. U.S. Provisional Patent Application No. 63/388,055 is incorporated herein by reference in its entirety. U.S. Provisional Patent Application No. 63/410,924 is incorporated herein by reference in its entirety.

### BACKGROUND

Current new radio (NR) uplink (UL) scheduling mechanisms may rely mainly on UL buffer status reports (BSRs) sent by a user equipment (UE). A UE also may be referred to herein as a wireless transmit/receive unit (WTRU). Typically, a WTRU may send a BSR after data has arrived at the WTRU, and UL transmission of the data does not commence until the WTRU is granted permission to do so. Scheduling based on such a request and/or grant mode may lead to high latency and extensive UL signaling, which may make it challenging, to provide services for delay intolerant services such as URLLC (Ultra Reliable Low Latency Communication) services.

### SUMMARY

Wireless communications between one or more user equipment (UE) and a network are considered herein. A UE also may be referred to as a wireless transmit/receive unit (WTRU). The terms UE and WTRU are used interchangeably herein.

Described herein are methods and apparatuses for accomplishing uplink (UL) scheduling. In examples, a WTRU may facilitate scheduling by providing its UL data prediction capabilities. The WTRU may be configured to utilize artificial intelligence (AI) and/or machine learning (ML) to accomplish UL data prediction. The WTRU may be configured to receive AI and/or ML (AI/ML) models for UL data prediction. The WTRU may receive an indication and/or be configured regarding the AI/ML model, capability, and/or configuration to employ for UL data prediction and/or generating a predictive buffer status report (BSR). The WTRU may receive a configuration from the network regarding the information to include in predictive BSR. The WTRU may receive a configuration from the network regarding the triggering conditions for the predictive BSR. The WTRU may receive an indication, from the network, to activate, start, and/or resume and/or deactivate, stop, and/or pause UL data prediction and/or associated predictive buffer status reporting. The WTRU may perform UL data predictions. The WTRU may send predictive BSRs when BSR triggering conditions are fulfilled. The WTRU may be configured to store predictive BSRs when UL resources are not available. The WTRU may send the predictive BSRs when resources become available (e.g., if resources become available within a certain time duration, etc.).

In examples, a WTRU may send an indication to a network regarding its UL data prediction capability. The WTRU may be in a connected mode. The WTRU may receive an indication and or a configuration from the network regarding the UL data prediction model(s)/capability(ies) to be used. The WTRU may receive a configuration from the network regarding a predictive BSR configuration (e.g., information to be included in the BSR, triggering conditions for the BSR such as buffer level thresholds, desired time horizons, and/or desired confidence levels, etc.). The WTRU may perform UL data prediction and/or monitor the predictive BSR triggering conditions. As used herein, UL data prediction refers to a prediction as to the amount of data the WTRU will have in its buffer ready to be sent. The WTRU also may perform UL traffic prediction. with the UL traffic prediction may include predictions as to data rate, and/or rate of change of data rates, etc. Upon a determination that the triggering condition(s) is/are fulfilled, the WTRU may construct the predictive BSR (e.g., a MAC CE) and may send the predictive BSR to the network.

In examples, a WTRU may include a processor and a transceiver configured to facilitate the following. The WTRU may be configured to send, via the transceiver, an indication to a network regarding its UL data prediction capability. The WTRU may be in a connected mode. The WTRU, may be configured to receive, via the transceiver, an indication and/or a configuration from the network regarding the UL data prediction model(s) and/or capability(ies) to be used. The WTRU may receive, via the transceiver, a configuration from the network regarding a predictive BSR configuration (e.g., information to be included in the BSR, triggering conditions for the BSR such as buffer level thresholds, desired time horizons, and/or desired confidence levels, etc.). The WTRU may be configured to perform UL data prediction and monitor the predictive BSR triggering conditions. The WTRU may be configured, upon a determination that the triggering condition(s) is/are fulfilled, to construct the predictive BSR (e.g., a medium access control control element (MAC CE) and/or send the predictive BSR to the network.

In examples, the UL data prediction capabilities may comprise an error margin, a time horizon, an indication of accuracy, a confidence level, an interval, or the like, or any appropriate combination thereof.

Different logical channel groups (LCGs) may indicate separate prediction capabilities. Different entries in the same LCGs may indicate separate prediction capabilities. Error margin values and/or percentages may be the same for each type of predictions within the same prediction time horizon. Accuracy and/or confidence levels for the lower and/or the upper margins of error may be separated. The WTRU may be configured to send a predictive BSR that includes the indication of accuracy, confidence level, and/or error margins. Described herein are a WTRU and a methods performed by the WTRU. In an example method for performing UL data prediction and reporting predicted UL buffer status, a WTRU may receive predictive BSR configuration information. The predictive BSR configuration information may indicate an associated time frame and at least one triggering condition. The WTRU may predict an amount of UL traffic corresponding to the associated time frame. The WTRU may determine that at least one of the at least one triggering conditions has been met.

The WTRU may send a predictive BSR, wherein the predictive BSR may comprise an indication of the predicted amount of UL traffic. The predictive BSR may be sent via a MAC CE.

The WTRU may send an indication of an UL traffic prediction capability of the WTRU. The predictive BSR configuration may include information for predicting the amount of UL traffic.

The predictive BSR configuration information may include at least one of artificial intelligence (AI)-related information, machine learning (ML)-related information, or a combination thereof. The AI-related information may include an AI model and the ML-related information may include a ML model. The AI-related information may include information about an identity of the AI model and the ML-related information may include information about an identity of the ML model.

The associated time frame may include at least one of a length of time over which the amount of UL traffic is predicted and/or a time frame over which the UL traffic is predicted. The amount of UL traffic may be predicted for a traffic type. The WTRU may predict the amount of UL traffic based on at least one of historical traffic volume information, historical transmission time information, historical arrival rate information, historical WTRU location information, and/or historical WTRU trajectory information. The at least one triggering condition may include an UL traffic prediction confidence level, an UL traffic transmission time, and/or an UL traffic volume amount. The UL traffic corresponding to the associated time frame may be based on at least one of an artificial intelligence (AI) algorithm, and/or a machine learning (ML) algorithm.

An example WTRU for performing UL data prediction and reporting predicted UL buffer status, may comprise a processor and transceiver. The processor may be configured to receive, via the transceiver, predictive BSR configuration information. The predictive BSR configuration information may indicate an associated time frame and at least one triggering condition.

The processor may be configured to predict an amount of UL traffic corresponding to the associated time frame. The processor may be configured to determine that at least one of the at least one triggering conditions has been met. The processor may be configured to send, via the transceiver, a predictive BSR, wherein the predictive BSR may comprise an indication of the predicted amount of UL traffic. The predictive BSR may be sent via a MAC CE. The processor may be configured to send, via the transceiver, an indication of an UL traffic prediction capability of the WTRU. The predictive BSR configuration may include information for predicting the amount of UL traffic.

The predictive BSR configuration information may include at least one of artificial intelligence (AI)-related information, machine learning (ML)-related information, or a combination thereof. The AI-related information may include an AI model and the ML-related information may include a ML model. The AI-related information may include information about an identity of the AI model and the ML-related information may include information about an identity of the ML model.

The associated time frame may include at least one of a length of time over which the amount of UL traffic is predicted and/or a time frame over which the UL traffic is predicted. The amount of UL traffic may be predicted for a traffic type. The processor may be configured to predict the amount of UL traffic based on at least one of historical traffic volume information, historical transmission time information, historical arrival rate information, historical WTRU location information, and/or historical WTRU trajectory information.

The at least one triggering condition may include an UL traffic prediction confidence level, an UL traffic transmission time, and/or an UL traffic volume amount. The UL traffic corresponding to the associated time frame may be based on at least one of an artificial intelligence (AI) algorithm, and/or a machine learning (ML) algorithm.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures and the detailed description are not to be considered limiting, and other equally effective examples are possible and likely. Like reference numerals (“ref.” or “refs.”) in the Figures indicate like elements.

FIG. 1A is an example system diagram illustrating an example communications system in which one or more disclosed embodiments may be implemented.

FIG. 1B is an example system diagram illustrating an example wireless transmit/receive unit (WTRU) that may be used within the communications system illustrated in FIG. 1A according to an embodiment.

FIG. 1C is an example system diagram illustrating an example radio access network (RAN) and an example core network (CN) that may be used within the communications system illustrated in FIG. 1A according to an embodiment.

FIG. 1D is an example system diagram illustrating a further example RAN and a further example CN that may be used within the communications system illustrated in FIG. 1A according to an embodiment.

FIG. 2 illustrates example buffer status report (BSR) formats of short BSR medium access control control element (MAC CE), extended short BSR, and long BSR MAC CE.

FIG. 3 depicts a table of example BSR buffer size levels, in bytes, for a 5-bit buffer size field.

FIG. 4 depicts a table of example BSR buffer size levels, in bytes, for an 8-bit buffer size field.

FIG. 5 is an example illustration of communications between a wireless transmit/receive unit (WTRU) and a network.

FIG. 6 is a flowchart depicting an example enhanced uplink (UL) scheduling mechanisms.

FIG. 7 is a flowchart depicting an example uplink scheduling system.

### EXAMPLE NETWORKS FOR IMPLEMENTATION OF THE INVENTION

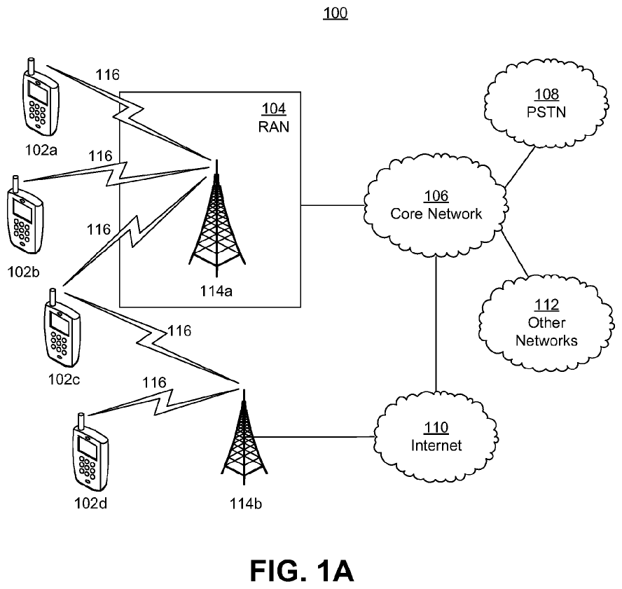

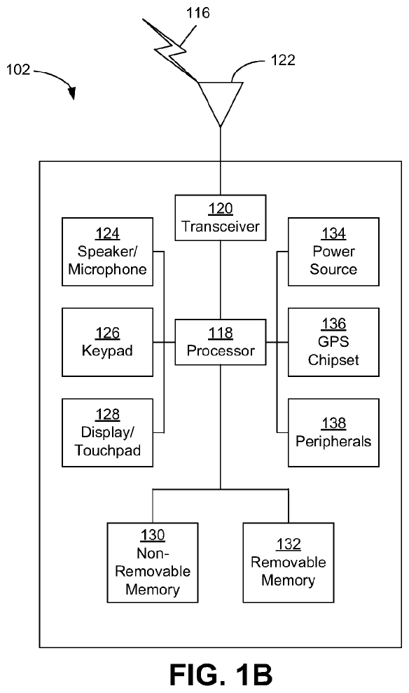

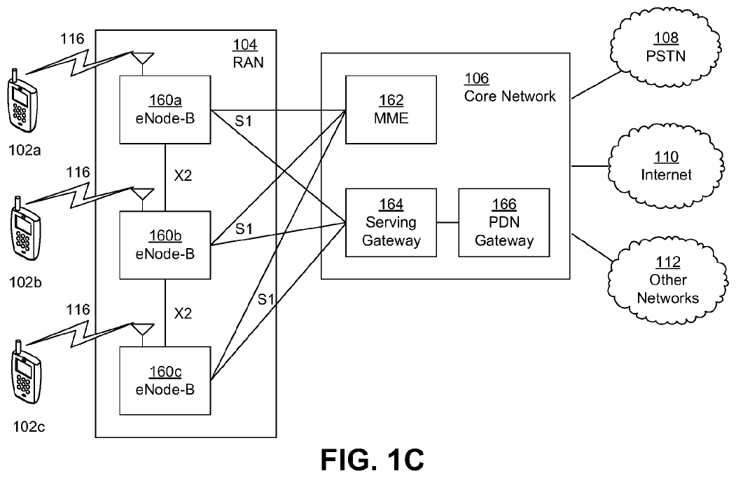

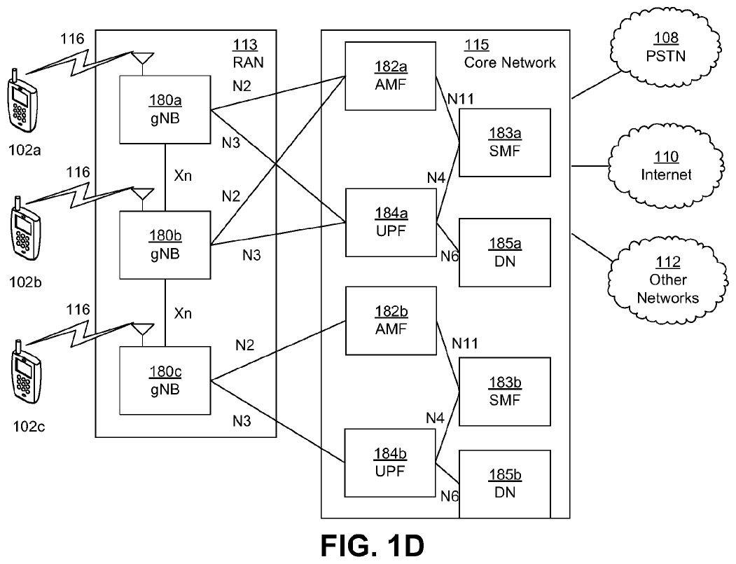

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (Qos) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation and/or deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHZ, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHz, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Described herein are methods and apparatuses that effectuate communications between WTRUs and/or networks. These communications may provide uplink (UL) scheduling for WTRUs comprising UL data prediction capabilities. Accordingly, a WTRU may communicate to a network the expected UL traffic via predictive buffer status reports (BSRs). The network may utilize that information for UL scheduling. The network may utilize information about predicted traffic as an input for network artificial intelligence/machine learning (AI/ML) models handling mobility optimization, load balancing, and/or in general any SON (self-organizing networks) functions.

As described herein, the term AI/ML is used to describe any model and/or associated learning algorithm, used by the WTRU and/or network for example, to predict future behavior (e.g., the behavior and/or data arrival at the WTRU to be sent to the network). The model and/or associated learning algorithm may utilize a big set of data collected by the WTRUs and/or network. The terms “expected,” “anticipated,” “estimated,” “predictive,” and/or “predicted” (and/or their adverb variants) may be used interchangeably. The term “time horizon” may be used to refer to the time at which the predicted UL data is expected to arrive (e.g., ready to be sent) by the WTRU after the reception of the predicted BSR. The term “normal BSR” may be used to describe BSR reporting that is triggered based on UL data that arrived at the WTRU (e.g., regular BSR, padding BSR, and/or periodic BSR, etc.).

The process of scheduling in new radio (NR) may involve a base station (e.g., next generation node B (gNB) and/or the like). Scheduling may involve a medium access control (MAC) entity of the gNB. The gNB may be responsible for the scheduling of both UL and downlink (DL) physical resources in NR. To accomplish resource efficient usage of the network's radio resources and/or do so fairly among the different WTRUs that the gNB serves, the gNB may utilize various types of information.

For example, the gNB may utilize the buffer status related to the WTRU (e.g., pending data to be transmitted at the gNB in the DL for the WTRU, UL buffer status reported by the WTRU, or the like, or any appropriate combination thereof, etc.). The gNB may utilize QoS requirements of each WTRU and associated radio bearers. The radio conditions at the WTRU (e.g., identified through measurements made at the gNB and/or reported by the WTRU). The gNB may utilize power headroom at the WTRU which may include the difference between the WTRU's maximum transmit power and estimated power for UL transmission (e.g., as indicated by power headroom reports from the WTRU).

The gNB may use this information when making scheduling decisions in the UL and/or DL (e.g., which WTRU(s) get which UL/DL resources to transmit and/or receive). The gNB may accomplish scheduling in a dynamic fashion (e.g., the WTRUs being scheduled and/or resources assigned to these WTRUs may change from one radio slot and/or frame to another). Additionally or alternatively, the gNB may accomplish scheduling in a persistent fashion (e.g., a certain set of radio resources allocated to a WTRU or group of WTRUs in the UL and/or DL for a given time). Persistent scheduling in the UL in NR may be referred to as configured grants and in the DL may be referred to as semi-persistent scheduling (SPS).

A gNB may dynamically allocate resources to WTRUs via the cell-radio network temporary identifier (C-RNTI) on physical downlink control channel(s) (PDCCH(s)). A WTRU may monitor the PDCCH(s) to find possible grants for UL transmission. When carrier aggregation (CA) is configured, the same C-RNTI may apply to all serving cells.

A gNB may cancel a physical uplink control channel (PUSCH) transmission, and/or a repetition of a PUSCH transmission, or a sounding reference signal (SRS) transmission of a WTRU for another WTRU with a latency-critical transmission. A gNB may configure WTRUs to monitor cancelled transmission indications using CI-RNTI on a PDCCH.

Alternatively or additionally, with configured grants, a gNB may allocate UL resources for the initial hybrid automatic repeat request (HARQ) transmissions and HARQ retransmissions to WTRUs.

In an example configuration, a WTRU may be configured with up to 12 active configured UL grants for a given bandwidth part (BWP) of a serving cell. When more than one UL grant is configured, the network may decide which of these configured uplink UL are active at a time. One or more or all uplink grants may be active at a time. Each configured UL grant may be of either Type 1 or Type 2.

For Type 2, activation and/or deactivation of configured UL grants may be independent among the serving cells. When more than one Type 2 configured grant is configured, each configured grant may be activated separately using a downlink control information (DCI) command. Deactivation of Type 2 configured grants may be done using a DCI command. This DCI command may either deactivate a single configured grant configuration or deactivate multiple configured grant configurations jointly.

UL BSRs may be utilized to provide support for QoS-aware packet scheduling. In NR, a BSR may be reported at a logical channel group (LCG) granularity. In an example configuration, a WTRU may be configured with up to 32 logical channel IDs (LCID), which may be grouped into as many as 8 LCGs. In various example configurations, a WTRU may be configured with more than 32 LCIDs and more than 8 LCGs (e.g., the mobile termination (MT) of an integrated access and/or backhaul (IAB) node may be configured with up to 65,855 LCIDs and/or 256 LCGs).

A BSR may be sent in any combination of formats, including: a short BSR format to report the data for only one LCG and/or a long BSR format to report the data from several LCGs.

MAC CEs may transmit BSRs. When a BSR is triggered (e.g., when new data arrives in the transmission buffers of the WTRU), and the WTRU does not have any available UL grants to send the BSR, the WTRU may transmit a scheduling request (SR) to request UL resources to transmit the BSR.

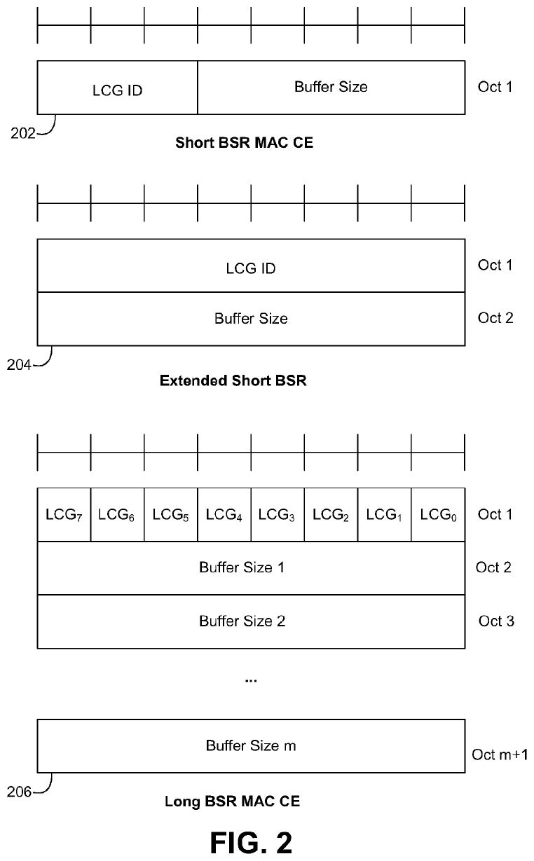

FIG. 2 illustrates example buffer status report (BSR) formats for a short BSR medium access control control element (MAC CE) 202, an extended short BSR 204, and a long BSR MAC CE 206. There are several variants of the short BSR 202 and long BSR 206 (e.g., for the case of IAB MT), a subset of which are illustrated FIG. 2. The identifiers Oct 1, Oct 2, Oct 3, . . . , Oct m+1 represent the octet number.

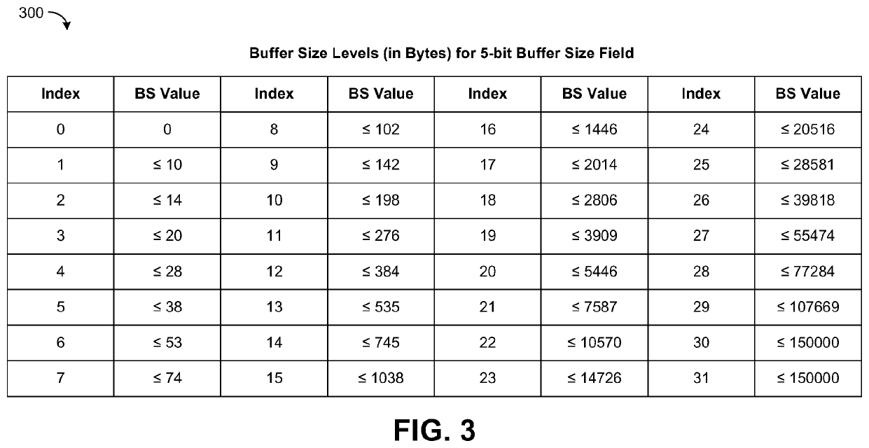

To reduce the signaling overhead in the BSR, buffer level indexes are used instead of the actual buffer sizes, where a buffer level index corresponds to a range of buffer sizes. The buffer size included in the BSR reports may be coded according to the table 300 depicted in FIG. 3 (e.g., the WTRU may include the index corresponding to the buffer size for the corresponding LCG.) FIG. 3 depicts a table 300 of example BSR buffer size levels, in bytes, for a 5-bit buffer size field.

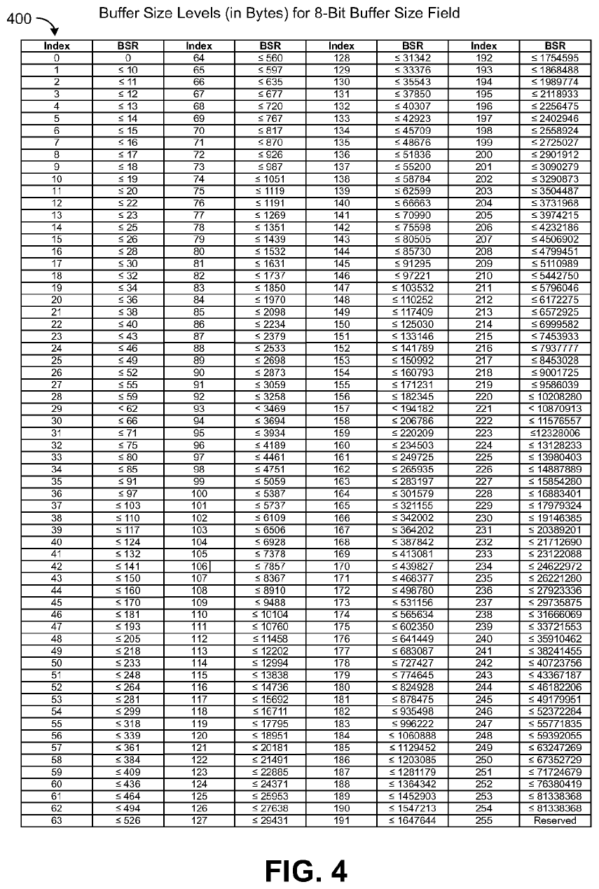

Similarly, FIG. 4 depicts a table 400 illustrating buffer size levels (in bytes) for 8-bit Buffer Size field.

The RRC may configure the following parameters to control the BSR: periodicBSR-Timer, retxBSR-Timer; logicalChannelSR-DelayTimerApplied; logicalChannelSR-DelayTimer; logicalChannelSR-Mask; and/or logicalChannelGroup.

The MAC entity may determine the amount of UL data available for a logical channel according to the data volume calculation procedure performed at radio link control (RLC) and packet data convergence protocol (PDCP). When doing the data volume calculation, RLC may include the RLC data protocol date units (PDUs) that are pending transmission or retransmissions, RLC service data units (SDUs) (or segments of RLC SDUs that have not been yet included in an RLC data PDU), and/or any pending RLC STATUS PDU. The data volume calculation at PDCP may consider the PDCP SDUs for which PDCP data PDUs have not been constructed, PDCP data PDUs that have not yet been transmitted to lower layers, any PDCP control PDUs, and/or any PDPC SDUs and/or PDUs that are to be retransmitted due to PDCP re-establishment or PDCP data recovery.

A WTRU may trigger a BSR if any combination of events occur. One such event may include when UL data for a logical channel which belongs to an LCG becomes available to the MAC entity. This UL data may belong to a logical channel with higher priority than the priority of any logical channel containing available UL data which belong to any LCG, and/or none of the logical channels which belong to an LCG contains any available UL data. In either case, the BSR is referred to as ‘Regular BSR.’

In examples, another such event may occur when UL resources are allocated and a number of padding bits is equal to or larger than the size of the BSR MAC CE plus its subheader. In this instance, the BSR is referred to as ‘Padding BSR.’

In examples, another such event may occur when retxBSR-Timer expires, and/or at least one of the logical channels which belong to an LCG contains UL data. In this instance, the BSR is also referred to as ‘Regular BSR.’

In examples, another such event may occur when periodicBSR-Timer expires. In this instance, the BSR is referred to as ‘Periodic BSR.’

When Regular BSR triggering events occur for multiple logical channels simultaneously, each logical channel may trigger one separate Regular BSR.

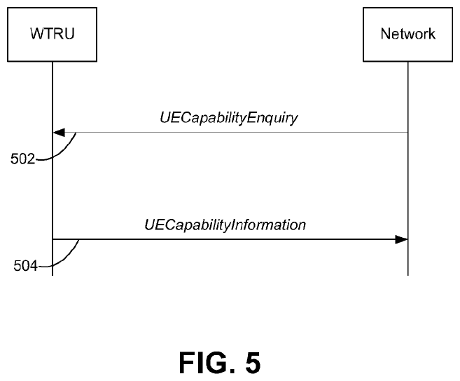

FIG. 5 is an example illustration of communications between a wireless transmit/receive unit (WTRU) and a network. As depicted in FIG. 5, in NR, the WTRU may receive a UECapabilityEnquiry message from the network at 502. The WTRU may then compile and/or transfer its WTRU capability information (e.g., supported frequencies, supported radio access technologies, and/or processing capabilities, etc.) upon receiving the UECapabilityEnquiry message from the network by sending a UECapabilityInformation message at 504.

The network may initiate the procedure to a WTRU in RRC_CONNECTED mode when it needs (e.g., additional) WTRU radio access capability information. In examples, the network may retrieve WTRU capabilities after AS security activation, and the network may not forward WTRU capabilities that were retrieved before AS security activation to the core network (CN).

The WTRU capability may be requested per Radio Access Technology (RAT) type (e.g., NR, evolved universal mobile telecommunication system terrestrial radio access (EUTRA), etc.,). Additional filters also may be included in the capability request to limit the UL signalling as the size of all the WTRU capability information may be substantial. Additionally, the network may already have some of the WTRU's capability information (e.g., from earlier capability transfer from the WTRU and/or from earlier capability transfer from the CN, etc.).

As discussed herein, NR UL scheduling mechanisms may rely on the reception of an UL BSR from a WTRU. The WTRU may send the UL BSR after the data has arrived at the WTRU and waiting to be sent. Scheduling based on such a request and/or grant mode of operation may lead to high latency and/or extensive UL signaling, which may impact delay intolerant services. A network may provide configured grants that may be available for a longer duration to alleviate the latency problem of request and/or grant-based scheduling. However, an inconsistent UL data rate may lead to an inefficient use of UL resources.

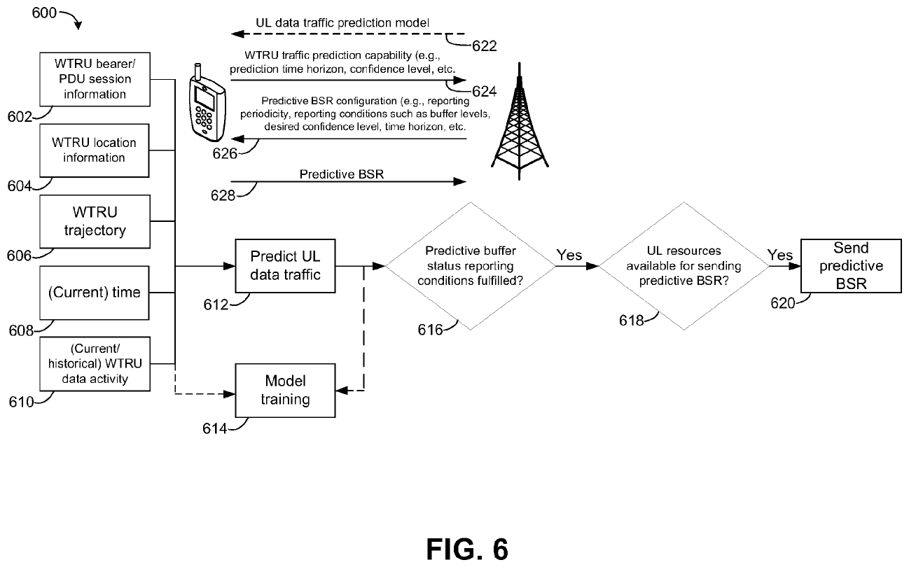

FIG. 6 is a flowchart 600 depicting an example enhanced uplink (UL) scheduling mechanism. FIG. 6 illustrates methods and apparatuses for enhancing UL scheduling mechanisms that may benefit from WTRU information on expected and/or anticipated UL data traffic.

A WTRU may communicate to a network the expected UL traffic via predictive BSRs. The network may use the information in the predictive BSRs to facilitate UL scheduling. In examples, the network may use any information about predicted traffic as an input for network AI/ML models handling mobility optimization, load balancing, and/or in general any SON (Self-Organizing Networks) functions.

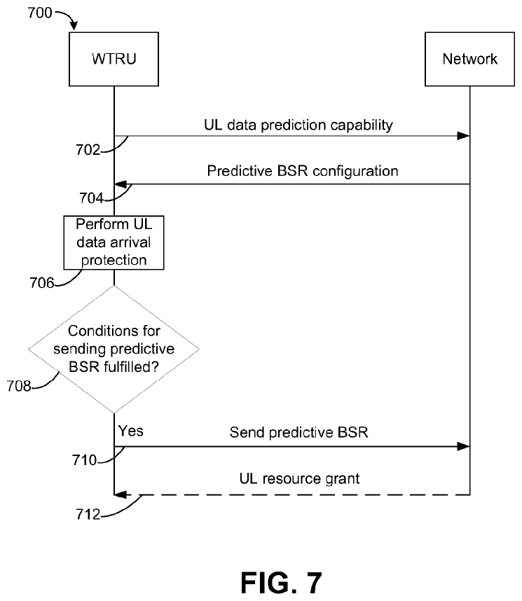

FIG. 7 is a flowchart 700 depicting another example uplink scheduling system. At 702, the WTRU informs the network about UL data prediction capability. At 704, the WTRU may receive configuration from the network related to predictive BSR. At 706 the WTRU may perform UL data arrival protection. At 708, the WTRU may determine whether the conditions for sending predictive BSR are fulfilled. Information the WTRU may consider when making the determination may include, e.g., reporting periodicity whether predictive BSR may be reported along with regular, periodic, or padding BSR, and/or separately. Information the WTRU may consider when making the determination may include prioritization compared to normal BSR. If there is a predictive BSR for an LCID/LCG with a higher priority than a normal BSR for an LCID/LCG with a lower priority, and/or the WTRU has an UL grant available to send only the normal and/or the predictive BSR, then the WTRU may prioritize the predictive one. Information the WTRU may consider when making the determination may include the timeline setting, e.g., how far in the future the predictions could be. The configuration may include thresholds for reporting, e.g., only if buffer size is expected to be above or below a certain threshold value or range of values. Information the WTRU may consider when making the determination may include an indication of the required prediction confidence level.

At 710, the WTRU may send predicted BSR to the network (e.g., periodically, and/or when the trigger thresholds are fulfilled, etc.). The predicted BSR may contain one or more set of the following information: data volume (an average value, a minimum value, a maximum value, a range, etc.); estimated time of arrival (e.g., exact timestamp, delta time, exact/delta time range, etc.); and/or prediction confidence level (e.g., a probability value or range of values). At 712 the WTRU receives the UL resource grant.

The WTRU may indicate to the network its capability to perform UL data prediction. For example, the WTRU may indicate to the network its capability according to WTRU capability transfer (e.g., network sending a UECapabilityEnquiry 502 and WTRU responding with UECapabilityInformation 504 as seen in FIG. 5. An information filtering capability related to the WTRU's UL data prediction may be introduced in the UECapabilityEnquiry 502 message. This capability information may be as simple as a binary “yes/no.” A response of “no” may indicate that the WTRU is not capable of UL data prediction (e.g., predicting how much data will be in the WTRU's buffer prior to sending the data). Thus, there may be no need for the WTRU to be configured for generating a predictive BSR. A response of “yes” may indicate that the WTRU is capable of UL data prediction (e.g., predicting how much data will be in the WTRU's buffer prior to sending the data). This “yes” response indicates to the network that the network may send the WTRU the configuration specifying the sending of the predictive BSR (e.g., when to trigger the predictive BSRs and/or what information to include in the predictive BSRs, etc.). A response of “yes” also may contain details as to the types of predictions the WTRU can make.

The response may be more detailed and contain, e.g., the following information, including prediction time horizon (e.g., WTRU may predict the UL data up to x ms in advance). In examples, the WTRU may indicate the capability in terms of a prediction time window length, (e.g., data is expected to arrive as early as x ms and as late as y ms). The response may include a confidence level of the prediction (e.g., the WTRU's confidence on the prediction is 95%). The response may include time duration(s) where the prediction is applicable (e.g., the WTRU may be able to provide an accurate prediction only during certain times of the day, such as 7:30 am and 8:00 am). The response may include location(s) where the predictions is applicable (e.g., range of global navigation satellite system (GNSS)/GPS co-ordinates, set of cell IDs, etc.).

The response may include granularity of prediction. Granularity of prediction may contain the following information, including the delta (plus or minus) to be applied to determine the range of expected data (e.g., a delta of d signifies that the network should consider the expected data rate to be between r-d and r+d, where ris the reported expected data rate from the WTRU). In examples, the WTRU may report a range of values without the need to communicate the delta. The information may include granularity level, e.g. whether the granularity level is at LCG level, more granular at the LCID level, less granular at the total UE buffer level, and/or something in between.

The WTRU may indicate to the network a plurality of UL data prediction capabilities. For example, a first capability (e.g., capability 1) may comprise a prediction for up to x1 ms in advance, confidence level c1, time duration t1, location l1, and/or a granularity of total UL buffer level. In examples, a second capability (e.g., capability 2) may comprise a prediction for up to x2 ms in advance, confidence level c2, time duration t2, location l2, and/or a granularity of LCGs.

The WTRU may indicate to the network whether the WTRU may perform a prediction according to only one prediction capability at a given time. Alternatively or additionally, the WTRU may perform multiple predictions at once. For example, the WTRU may indicate that it may be capable of performing the UL data prediction at a given time according to any combination of the conditions. These conditions may include only one of the indicated capabilities, a subset of the indicated capabilities (e.g., capability 1 and 2, capability 1 and 3, capability 2, 4, and 5, etc.), all the indicated capabilities as long as some capabilities are not employed together (e.g., capabilities 1 and 3 cannot be used at the same time), and/or all the indicated capabilities. If the WTRU cannot perform the prediction according to all its capabilities at once, the WTRU may indicate to the network the preference level of the different capabilities and/or sets of capabilities that may be employed together.

The network may indicate to the WTRU the UL data prediction capability (or capabilities) to be employed. For example, once the network has received an indication that the WTRU supports a certain number of UL data prediction capabilities, the network may configure the WTRU to operate the UL data prediction. The network may indicate to the WTRU to perform the UL data prediction according to more than one UL prediction capability (simultaneously). The network may indicate to the WTRU to perform the UL data prediction according to more than one UL prediction capability. The WTRU may indicate the chosen capability (or capabilities) in a response message. For example, the network may indicate to the WTRU to predict the UL traffic according to capability 1 or 2. The WTRU may choose an appropriate capability (e.g., capability 1 or capability 2), and send a message to the network indicating the chosen prediction capability. The network may indicate to the WTRU to perform the UL data prediction according to more than one UL prediction capability. The network may include further constraints regarding when the WTRU should perform the UL prediction according to the indicated capabilities. For example, the network may indicate to the WTRU to have capability 1 to be used during a certain time period (e.g., between 8 am and 8:30 am) and/or a certain location (e.g., range of GNSS locations, cell identities, while being served by certain RATs and/or frequencies, etc.). Additionally or alternatively, to absolute time and/or location constraints, the network may indicate relative constraints (e.g., delta time and/or location from the current time and/location).

A combination of the above two examples may be configured, (e.g., the network may implement a constraint regarding when/where the predictions are to be performed and/or reported, such as, e.g., time and/or location). The WTRU may decide which prediction capability to employ.

An RRC message may indicate to the WTRU the configuration of the capability (or capabilities) to be employed for UL data prediction. An MAC CE may indicate to the WTRU the configuration of the capability (or capabilities) to be employed for UL data prediction. A DCI may indicate to the WTRU the configuration of the capability (or capabilities) to be employed for UL data prediction.

The network may configure the WTRU with the AI/ML model used for UL data prediction. The network may configure the WTRU, in addition to the UL data prediction model, with conditions when to send a predicted BSR. These conditions may be based on the inference from this model, such as, e.g., immediately, as long as the trigger conditions are fulfilled, after the WTRU has done the training of the model for a certain specified duration, after the WTRU has compared the predicted UL data values with the actual values, and/or have determined that the accuracy and/or confidence level is above a configured threshold, etc.

The WTRU may be configured with AI/ML model(s) for UL data prediction, wherein the specific inputs to AI/ML models are preconfigured. For example, the WTRU may be configured to input historical data volume, time stamps, data arrival rates for preconfigured LCID and/or LCGs, etc. (see, e.g., step 626 in FIG. 6). In examples, the WTRU may be configured with AI/ML models specific to a LCG, e.g., the WTRU may be configured with plurality of AI/ML models. The WTRU may apply different AI/ML models for different LCGs.

The WTRU may consider the choice of the capability (or capabilities) to be used for the UL prediction by the network. The WTRU may make this consideration to start the UL data prediction and/or reporting according to the chosen and/or indicated capability (or capabilities). In examples, if constraints (e.g., time and/or location, etc.) were configured for a prediction described herein, the WTRU may perform the prediction and/or reporting only when under those constraints.

The WTRU may wait for the reception of an additional explicit activation message and/or indication to start UL data prediction reporting. If more than one capability was chosen and/or configured, the capability (or capabilities) to be employed for the UL data prediction and/or reporting may be included in the activation message and/or indication. If more than one capability was chosen and/or configured, the network may indicate to the WTRU with an explicit flag to employ all capabilities at once instead of separately including all the chosen capabilities.

The WTRU may receive a deactivation message and/or indication to stop performing and/or reporting the UL data prediction. If more than one capability activated, the capability (or capabilities) to deactivate for the UL data prediction and/or reporting may be included in the deactivation message and/or indication. If more than one capability activated and the network wants to stop all UL prediction and/or reporting, the network may indicate this cessation of all UL prediction and/or reporting using an explicit flag instead of separately including all the prediction capabilities to be deactivated. In examples, the WTRU may perform activation and/or deactivation of the UL prediction and/or reporting upon the reception of such a message.

Additional information can be included in the activation and/or deactivation message indicating when the message should take effect. For example, a delta time may be included in the deactivation message, and the WTRU may wait until the indicated delta time has elapsed after the reception of the deactivation message before deactivating the UL data prediction and/or reporting (either according to the indicated capability or all UL data prediction if that was indicated). The activation and/or deactivation signaling may be performed via RRC. A MAC CE may be used for the activation and/or deactivation signaling. A DCI may be used for the activation and/or deactivation signaling.

The logical channel grouping used for predicted BSR may be the same as the logical channel grouping that is employed for normal BSR. A different logical channel grouping may be used for predicted BSR as compared to the logical channel grouping employed for normal BSR. For example, a new information element (IE) may be introduced in the logical channel group configuration indicating the LCG ID for a given logical channel in addition to the legacy logicalChannelGroup IE. UL buffer level indices may comprise any appropriate buffer level indices, such as, e.g., current buffer level indices, new buffer level indices, and/or any combination thereof. New UL buffer level indices may be used for predictive BSRs (e.g., with less or more granularity and/or size limits than those for normal BSRs).

The WTRU may be configured to send predicted UL buffer status reports periodically. The periodicity for the predicted UL buffer status may be configured as the same periodicity of normal BSRs. The periodicity may be assumed implicitly (e.g., the WTRU implicitly adopting the periodicity of the normal BSR for reporting of predicted BSR). The periodicity may be indicated to the WTRU explicitly (e.g., a flag in the predicted UL buffer status reporting configuration indicating to the WTRU to use the same periodicity as for normal BSR). The periodicity for the predicted UL buffer status may be configured to be different from the normal BSR. The WTRU may be configured to apply similar behavior as in regular BSR of normal BSRs, e.g., when new data is expected to arrive in the UL buffer that has a higher priority than the data already waiting in the buffer. The WTRU may be configured to send a predicted BSR report when new data is expected to arrive in the UL buffer. This data may have the same or even lower priority than the one already waiting in the buffer, depending upon the expected buffer size of the new data (e.g., whether the data exceeds a certain configured threshold).

The WTRU may be configured to send a predicted BSR report when new data is expected to arrive in the UL buffer that has the same or even lower priority than the one already waiting in the buffer, depending on the difference between the expected buffer size of the new data and that is already waiting in the buffer of a high priority data (e.g., if the difference is above a certain configured threshold. The buffer level threshold for triggering a predicted BSR may be configured to be the same for all LCGs, or different for each LCG. The buffer level threshold for triggering a predicted BSR for a certain LCG may be configured to the predicted UL buffer for that LCG plus the current UL buffer level for that LCG. The buffer level threshold for triggering a predicted BSR may be configured to the total predicted UL buffer (e.g., over all the LCGs). The buffer level threshold for triggering a predicted BSR may be configured to the total predicted UL buffer (e.g., over all the LCGs) plus the current total UL buffer level.

Triggering of the predicted BSR may be configured to be controlled by the desired confidence level of the prediction. For example, the network may authorize the WTRU to predict according to any capability. The network may configure the WTRU to report only when the confidence level exceeds a certain desired threshold. Triggering of the predicted BSR may be configured to be controlled by the desired time horizon of the prediction. For example, the network may leave authorize the WTRU to predict according to any capability. The network may configure the WTRU to report predictions within the configured time horizon of the prediction report (e.g., only send predictions concerning the next x ms, only send predictions that are concerning the time periods between x ms and y ms, and/or only send predictions that are concerning the time periods after y ms, etc.).

The predicted UL buffer status report may include just the buffer level index. The network may implicitly find information regarding the confidence level, and/or the time horizon, etc. from the capability indication from the WTRU. The network may also discover information from the corresponding configuration the network sent to the WTRU according, and/or any further indication received from the WTRU, discussed herein. The predicted UL buffer status report may include an indication of the UL prediction capability corresponding to the concerned report (e.g., prediction capability ID). The network may use this indication to determine the confidence level, and/or the time horizon, etc. from the previously indicated capability information from the WTRU. The predicted UL buffer status report may include an indication of the time horizon for the UL prediction, confidence level for the UL prediction, and/or range of the prediction values instead of a given value and/or buffer index level (e.g., between level 1 and level 2). The predicted UL buffer status report may include several values and/or ranges of values for a given LCG (e.g., with different time horizons, confidence levels, and/or value ranges). One of the reserved LCID values in MAC specification (e.g., an LCID between 35 and 44) may indicate that the BSR is a predictive BSR.

In examples, the WTRU may send a predicted BSR if there are UL resources available (e.g., no SR triggered for the sending of predicted BSRs). The WTRU may send a predicted BSR as a padding BSR. The WTRU, upon determining that there are no resources to send the predicted BSR, may discard the predicted BSR. The WTRU, upon determining that there are no resources to send the predicted BSR, may store the predicted BSR, and/or send the predicted BSR when UL resources become available. The WTRU, on triggering a predicted BSR while another predicted BSR is pending to be sent, may discard the old predicted BSR and/or store the new predicted BSR for sending when UL resources become available. The WTRU, on triggering a predicted BSR while another predicted BSR is pending to be sent, may discard the new predicted BSR and/or keep the old predicted BSR for sending when UL resources become available.

The WTRU, on triggering a predicted BSR while another predicted BSR is pending to be sent, may compare the two BSRs and/or decide to keep one. For example, the WTRU may keep the BSR triggered due to higher priority LCIDs and/or LCGs, the BSR that includes information about higher priority LCIDs and/or LCGs, and/or the BSR that indicates higher buffer thresholds, etc.

The WTRU, on triggering a predicted BSR while another predicted BSR is pending to be sent, may combine the two BSRs. For example, if the two BSRs were disjointed (e.g., the two BSRs do not refer to the same LCGs), the WTRU may append the two BSRs together in a long BSR format, if the two BSRs have common parts (e.g., one or more LCGs included in the two BSRs are the same). The WTRU may include both BSRs in a new BSR format that includes multiple entries for the same LCGs but with different time horizons, if the two BSRs have common parts (e.g., one or more LCGs included in the two BSRs are the same). The WTRU may keep one entry for the combined BSR with a buffer value corresponding to the first BSR (e.g., earlier time horizon) if the two BSRs have common parts (e.g., one or more LCGs included in the two BSRs are the same). The WTRU may keep one entry for the combined BSR with a buffer value corresponding to the BSR that indicated a higher confidence level.

The WTRU may be configured with a threshold time duration (e.g., storage timer) that can keep a predicted BSR pending. When the predicted BSR triggers, a timer may start. If the timer expires before the predicted BSR was sent, the WTRU may discard the predicted BSR. The threshold time duration for keeping the pending BSRs may be related to the time horizon of the prediction (e.g., equal to the time horizon, and/or a specified fraction of the time horizon, etc.). The threshold time duration for keeping the pending BSRs may not be related to the time horizon of the prediction and/or configured separately.

A WTRU configured to store a predictive BSR for a certain duration and/or until UL resources are available as disclosed herein, may be configured to include information that this BSR has been delayed (when sending the BSR later). For example, the WTRU may include information in the MAC CE header describing how long the BSR has been pending to be sent. The WTRU may update the time horizon information if the time horizon information were included in the BSR. The WTRU may update the time horizon information to reflect the time when to expect the data indicated in the BSR.

Storage of the predicted BSRs upon determining that there are no UL resources available may be constrained by configured conditions. These configured conditions may include, e.g., buffer levels in the concerned BSRs (e.g., only store the BSRs that are indicating buffer levels above, below, and/or within a configured threshold); time horizon of the predictions; explicit time window (e.g., WTRU configured to store only predictive BSRs made between time1 and time2, where these times refer to absolute times); the LCG and/or LCID that triggered the BSR (e.g., store the BSR only if the BSR triggered due to a certain and/or a set of LCGs and/or LCIDs); the LCG and/or LCID included in the BSR (e.g., store the BSR only if the BSR contains information regarding to a certain and/or a set of LCGs and/or LCIDs); and amount of pending BSRs already stored and/or pending to be sent (e.g., store a newly triggered BSR only if the size of the stored pending BSRs is below a certain threshold).

The WTRU may be configured to keep the predictive BSRs even after the storage timer has expired, but not send these predictive BSRs immediately when UL resources become available. Instead, the WTRU may send an indication to the network that the WTRU has stored predictive BSR (e.g., including information such as the number of stored BSRs, time when these BSRs were generated, and/or size of the BSRs, etc.). The WTRU may be configured to keep the predictive BSRs even after the storage timer has expired, but not send these predictive BSRs immediately when UL resources become available. Instead, the WTRU may wait for an explicit request from the network to send stored BSRs.

Starting a timer (e.g., delay and/or prohibit timer) whenever a predictive BSR is sent may prevent sending frequent predictive BSRs. The WTRU may be configured with one timer value for all predictive BSRs, regardless of the LCG and/or LCID that triggered the BSR. The WTRU may start this timer whenever any predictive BSR is sent and/or refrains from sending another predictive BSR before the currently running timer expires. The WTRU may be configured with separate timer values for predictive BSRs triggered for each LCID and/or LCG. The WTRU may start a timer with a value corresponding to the timer associated with the LCID and/or LCG that triggered the predictive BSR. The WTRU may start a timer whenever any predictive BSR is sent and may refrain from sending another predictive BSR before the currently running timer expires.

The WTRU may be configured with one timer value for all predictive BSRs, regardless of the LCG and/or LCID that triggered the BSR. The WTRU may start this timer whenever any predictive BSR is sent. While this timer runs, the WTRU may refrain from sending another predictive BSR that also triggered due to the same LCID and/or LCG as the last sent predictive BSR. The WTRU may restart the currently running timer and/or send a new predictive BSR if that BSR triggered due to an LCID and/or LCG that is different from the LCID and/or LCG that triggered the last sent predictive BSR.

The WTRU may be configured with separate timer values for predictive BSRs that triggered for each LCID and/or LCG. The WTRU may start a timer with a value corresponding to the timer associated with the LCID and/or LCG that triggered the predictive BSR whenever any predictive BSR is sent. While this timer runs, the WTRU may refrain from sending another predictive BSR that also triggered due to the same LCID and/or LCG as the last sent predictive BSR. The WTRU may stop the currently running timer and/or send a new predictive BSR if that BSR triggered due to an LCID and/or LCG that is different from the LCID and/or LCG that triggered the last sent predictive BSR. The WTRU may restart the timer with a value corresponding to the concerned LCID and/or LCG.

The WTRU may be configured with one timer value for predictive BSRs that triggered due to some specific LCIDs and/or LCGs. No prohibit timer may be used for the rest of the LCIDs and/or LCGs. The WTRU may start the timer whenever a triggered predictive BSR is associated with the delay timer. The WTRU may refrain from sending another predictive BSR triggered by an LCID and/or LCG associated with a delay timer before the currently running delay timer expires. Predictive BSRs triggered by an LCID and/or LCG not associated with a timer may not be affected by the timer (e.g., predictive BSRs will be sent whether the delay timer runs or not), and/or the WTRU may stop the prohibit timer, if running, upon sending the BSR.

The WTRU may be configured with one timer value for predictive BSRs triggered due to some specific s and/or Ls, while no prohibit timer may be used for the rest of the LCIDs and/or LCGs. The WTRU may start the timer whenever a predictive BSR associated with the delay timer triggers. The WTRU may refrain from sending another triggered predictive BSR by the same LCID and/or LCG as the last predictive BSR before the currently running delay timer expires. Predictive BSRs not triggered due to an LCID and/or LCG that are different from the last LCID and/or LCG that triggered the BSR may not be affected whether the LCID and/or LCG has an associated timer or not. For example, predictive BSRs may be sent whether the delay timer runs or not. The WTRU may stop a running prohibit timer upon sending a predictive BSR triggered due to an LCID and/or LCG that has no associated timer. The WTRU may restart the timer with a value corresponding to the delay timer associated with the LCID and/or LCG, if the LCID and/or LCG has an associated delay timer.

The WTRU may be configured with separate timer values for triggered predictive BSRs due to some specific LCIDs and/or LCGs, while no prohibit timer is used for the rest of the LCIDs and/or LCGs. The WTRU may apply a behavior like those described herein for the case of one timer value. However, each time the timer starts, the value of the timer associated with the LCID and/or LCG that triggered the predictive BSR may be used.

The delay timer value used may not be the delay timer value associated with the LCG and/or LCID that triggered the predictive BSR. The delay timer may be the largest delay timer value among all the delay timer values configured for the other LCID and/or LCGs included in the predictive BSR to be sent.

The delay timer value used may not be the delay timer value associated with the LCG and/or LCID that triggered the predictive BSR. The delay timer may be the smallest delay timer value among all the delay timer values configured for the other LCID and/or LCGs included in the predictive BSR to be sent.

The delay timer value used may not be the delay timer value associated with the LCG and/or LCID that triggered the predictive BSR. The delay timer may be the mean delay timer value of all the delay timer values configured for the other LCID and/or LCGs included in the predictive BSR to be sent. The timer value may be specified for normal BSRs and/or predictive BSRs.

A WTRU may refrain from sending normal BSRs when a running BSR delay timer started due to a normal BSR. The WTRU may still send newly triggered predictive BSRs while such timer runs. The WTRU may refrain from sending only predictive BSRs when a running BSR delay timer started due to a predictive BSR. The WTRU may still send newly triggered normal BSRs while such timer runs. The WTRU may refrain from sending any BSR (e.g., normal and/or predictive) whenever a running BSR delay timer started due to the sending of a normal BSR. The WTRU may refrain from sending any BSR (e.g., normal and/or predictive) whenever a running BSR delay timer started due to the sending of a predictive BSR. The WTRU may refrain from sending any BSR (e.g., normal and/or predictive) whenever a BSR delay timer runs (e.g., whether the previous BSR that was sent was a normal and/or predictive BSR).

If a normal and/or predicted BSR trigger at the same time, the WTRU may delete the predicted BSR and try to send only the normal BSR; the WTRU may delete the normal BSR and try to send only the predicted BSR; and/or the WTRU may prioritize the sending of the normal BSR. For example, the predictive BSR may not be sent at all and/or only sent if UL resources remain available after the sending of the normal BSR. For example, the normal BSR may be sent first and/or wait to send the predictive BSR until further UL resources become available. If UL resources are not available to send even the normal BSR, an SR indicating the availability of a normal BSR may be sent. If UL resources are not available to send even the normal BSR, an SR indicating the availability of both a normal BSR and/or a predictive BSR may be sent.

If a normal and/or predicted BSR trigger at the same time, the WTRU may decide which one to prioritize. If a normal and/or predicted BSR trigger at the same time, the WTRU may prioritize the BSR triggered due to an LCID and/or LCG with a higher priority. If normal and/or predicted BSR trigger at the same time, the WTRU may combine the BSR report from both normal and/or predicted BSR. The WTRU may include in the BSR report the buffer sizes according to the LCID and/or LCG priority irrespective of whether the sizes are predicted and/or actual with some indication of BSR type. In case the normal and/or predicted BSR belong to the same LCID and/or LCG, the WTRU may include only the normal BSR for such LCID and/or LCG. If a normal and/or predicted BSR trigger at the same time, the WTRU may prioritize the predictive BSR if the indicated buffer level (for a given LCID and/or LCG or the total buffer level) exceeds a certain configured threshold. If a normal and/or predicted BSR trigger at the same time, the WTRU may prioritize the predictive BSR if the indicated buffer level (e.g., for a given LCID and/or LCG and/or the total buffer level) exceeds a certain configured threshold as compared with the buffer level in the regular BSR.

The WTRU's traffic prediction capability (e.g., at different prediction time horizons, and/or different traffic and/or bearer types, etc.) may be estimated to have an accuracy and/or confidence level of x %. However, the WTRU's traffic prediction capability may vary depending on several factors, including, e.g., the behavior of the end user, the dynamic nature of data traffic, especially interactive and/or real-time traffic, etc. The WTRU's traffic prediction capability may be difficult to have one specific accuracy and/or confidence level for predictions. The WTRU's traffic prediction capability may be difficult to have one specific value for the predictions.

The WTRU may indicate to the network a WTRU prediction capability for each traffic type (e.g., all traffic types) or certain traffic type(s) (e.g., specific prediction time horizon, etc.) that has a confidence interval between two values (e.g., between 75% and 85%). The WTRU may indicate a range of accuracy and/or confidence interval when sending predictive BSRs (e.g., when explicitly communicating the accuracy and/or confidence according to any of the described embodiments herein). Within a given predictive BSR report, there may be several entries with different prediction accuracy and/or confidence levels or ranges. Several entries with different prediction accuracy and/or confidence level or ranges may comply within a given predictive BSR report. For example, a predictive BSR may indicate different prediction accuracy and/or confidence levels and/or ranges for different LCGs. For example, LCG A may have a predicted traffic level of: X bytes, a time horizon of t1, and/or a confidence of 75% to 90%. LCG B may have a predicted traffic level of: Y bytes, a time horizon of t2, with a confidence level of 85% to 90%.

The WTRU may indicate to the network a WTRU prediction capability for each traffic type (e.g., all traffic types) and/or certain traffic type(s) (e.g., specific prediction time horizon, etc.,). These traffic types may have an associated error margin with a certain confidence interval. For example, a capability may indicate that the WTRU may perform the UL data traffic prediction with a confidence of 85% and/or the predicted values may fall within a predicted value, (e.g. lower margin and/or predicted value plus upper margin). The WTRU may indicate the error margin when sending predictive BSRs (e.g., when the accuracy and/or confidence level is explicitly communicated as described herein). For example, a predictive BSR may indicate different prediction accuracy and/or confidence levels and/or ranges for different LCGs. In an example, LCG A may have a predicted traffic level of: X bytes, a time horizon of t1, a confidence of 75% to 90%, a lower margin of x1 bytes, and/or an upper margin of x2 bytes. LCG B may have a predicted traffic level of Y bytes, a time horizon of t2, a confidence of 85% to 90%, a lower margin of y1 bytes and/or an upper margin of y2 bytes. When the network gets such a BSR, the expected traffic for LCG A may be expected to fall between X−x1 and X+x2 bytes, with a confidence level of 75% to 90%.

Examples indications contained in a BSR are described below. However, each of the examples described below may be applicable at the WTRU capability level. For example, a WTRU may indicate its capabilities in a similar way but indicate confidence levels and/or error margins in different ways. A network may choose a particular capability and/or indicate to the WTRU to send predictive BSRs that satisfy a certain confidence level and/or error margins, etc.

A WTRU may provide error margins and the network may assign a default confidence level. For example, LCG A may have a predicted traffic level of X bytes, a time horizon of t1, a lower margin x1 bytes, and/or an upper margin x2 bytes. When the network gets such a BSR, the expected traffic for LCG A may be expected to fall between X−x1 and X+x2 bytes, with a default confidence level, such as 100%, for example.

Instead of separately communicating lower and/or upper margins, the prediction capability may directly indicate the predicted traffic range. For example, LCG A may have a predicated traffic level of [X1-X2] bytes, a time horizon of t1, with a confidence level of 75% to 90%.

Even for the same traffic type (and/or traffic group), several entries may be made indicating different confidence levels, error margins, and/or time horizons, etc. For example, LCG A may have a predicted traffic level of [A1-A2] bytes, a time horizon of t1, a confidence of 75% to 90%. LCG A may have another predicted traffic level of [B1-B2] bytes, a time horizon of t1, with a confidence level of 85% to 95%. LCG A may have another predicted traffic level of [C1-C2] bytes, a time horizon of t2, with a confidence level of 75% to 90%.

Lower and/or upper error margins may be indicated in percentages rather than absolute values. For example, LCG A may have a predicted traffic level of X bytes, a time horizon of t1, a confidence level of 75% to 90%, a lower margin x1%, and/or an upper margin x2%. When the network gets such a BSR, the network may conclude that the expected traffic for LCG A may be expected to fall between (1−x1)*X and (1+x2)*X bytes, with a confidence level of 75% to 90%.

Error margin values and/or percentages may be the same for each type of predictions (e.g., all types of predictions) that has the same prediction time horizon.

There may be separate accuracy and/or confidence levels for lower and/or upper margins of error. For example, LCG A may have a predicted traffic level of X bytes, a time horizon of t1, a lower margin x1%, an upper margin x2%, with a lower margin confidence level of 75% to 80%, and/or an upper margin confidence level of 90% to 95%.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods, apparatuses, and articles of manufacture, within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

Although foregoing embodiments may be discussed, for simplicity, with regard to specific terminology and structure, (e.g., radio frequency (RF), microwave, centimeter wave, micrometer wave, infrared (IR), ultraviolet (UV), visible light, etc.), the embodiments discussed, however, are not limited to thereto, and may be applied to other systems that use other forms of electromagnetic waves or non-electromagnetic waves such as acoustic waves, for example.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis, or the like, or any appropriate combination thereof. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to Figures. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media, which are differentiated from signals, include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of methods, apparatuses, articles of manufacture, and systems provided above are possible without departing from the scope of the invention. In view of the wide variety of embodiments that can be applied, it should be understood that the illustrated embodiments are examples only, and should not be taken as limiting the scope of the following claims. For instance, embodiments provided herein include handheld devices, which may include or be utilized with any appropriate voltage source, such as a battery or the like, providing any appropriate voltage.

Moreover, in embodiments provided herein, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In example embodiments, several portions of the subject matter described herein may be implemented via Application Specific Integrated Circuits (ASICs), Field Programmable Gate Arrays (FPGAs), digital signal processors (DSPs), and/or other integrated formats. Those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. Those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

What is claimed is:

1-20. (canceled)

21. A wireless transmit/receive unit (WTRU) comprising a processor and a memory, the processor configured to:
send a first indication indicating a traffic prediction capability of the WTRU;
receive, based on the first indication of the traffic prediction capability, information indicating a predictive buffer status report (BSR) configuration, wherein the predictive BSR configuration indicates a length of time associated with predicting traffic for a BSR associated with at least one traffic type and indicating one or more triggering conditions for transmitting a predictive BSR for the at least one traffic type;
determine that at least an amount of traffic for the at least one traffic type over a period of time corresponding to the indicated length of time;
determine that at least one of the one or more triggering conditions is satisfied; and
send a triggered BSR comprising an indication of the determined amount of traffic.

22. The WTRU of claim 21, wherein the predictive BSR configuration comprises information used by the WTRU to predict the amount of traffic in response to the indication of the traffic prediction capability.

23. The WTRU of claim 21, wherein the processor is further configured to:
determine the amount of traffic by predicting the amount of traffic based on one or more of historical data volume information, historical transmission time information, or historical data arrival rates.

24. The WTRU of claim 21, wherein the triggered BSR further comprises one or more of a predicted time of data transmission or an indication of a prediction confidence level.

25. The WTRU of claim 24, wherein the processor is further configured to:
send a second indication indicating an interval that defines the range of the confidence level provided by the indication of a prediction confidence level.

26. The WTRU of claim 21, wherein the at least one traffic type is a logical channel group (LCG).

27. The WTRU of claim 21, wherein the indication indicating a traffic prediction capability of the WTRU comprises one or more of prediction time window length, confidence level of the prediction, time duration of the prediction, locations where the prediction is acceptable, or the granularity of the prediction.

28. The WTRU of claim 21, wherein the triggering conditions comprise one or more of a buffer level threshold for one or more logical channel groups (LGCs), desired confidence level of the predictive BSR, or a desired time horizon of the predictive BSR.

29. The WTRU of claim 27, wherein the granularity of the prediction comprises one or more of a parameter applied to a range of expected data, wherein the applied parameter expands the limits of the range of expected data.

30. The WTRU of claim 21, wherein the WTRU is further configured with a threshold timer, wherein the timer activates when the one or more triggering conditions is satisfied, and the BSR is sent during the activation of the timer.

31. A method implemented by a wireless transmit/receive unit (WTRU), the method comprising:
sending a first indication indicating a traffic prediction capability of the WTRU;
receiving, based on the first indication of the traffic prediction capability, information indicating a predictive buffer status report (BSR) configuration, wherein the predictive BSR configuration indicates a length of time associated with predicting traffic for a BSR associated with a least one traffic type and one or more triggering conditions for transmitting a predicative BSR for the at least one traffic type;
determining that at least an amount of traffic for the at least one traffic type over a period of time corresponding to the indicated length of time;
determining that at least one of the one or more triggering conditions is satisfied; and
sending a triggered BSR comprising a second indication of the determined amount of traffic.

32. The method of claim 31, wherein the predictive BSR configuration comprises information used by the WTRU to predict the amount of traffic in response to the indication of the traffic prediction capability.

33. The method of claim 31, wherein the processor is further configured to:
determine the amount of traffic by predicting the amount of traffic based on one or more of historical data volume information, historical transmission time information, or historical data arrival rates.

34. The method of claim 31, wherein the triggered BSR further comprises one or more of a predicted time of data transmission or an indication of a prediction confidence level.

35. The method of claim 34, further comprising:
sending a second indication indicating an interval that defines the range of the confidence level provided by the indication of a prediction confidence level.

36. The method of claim 31, wherein the at least one traffic type is a logical channel group (LCG).

37. The method of claim 31, wherein the indication indicating a traffic prediction capability of the WTRU comprises one or more of prediction time window length, confidence level of the prediction, time duration of the prediction, locations where the prediction is acceptable, or the granularity of the prediction.

38. The method of claim 31, wherein the triggering conditions comprise one or more of a buffer level threshold for one or more logical channel groups (LGCs), desired confidence level of the predictive BSR, or a desired time horizon of the predictive BSR.

39. The method of claim 37, wherein the granularity of the prediction comprises one or more of a parameter applied to a range of expected data, wherein the applied parameter expands the limits of the range of expected data.

40. The method of claim 31, wherein the WTRU is further configured with a threshold timer, wherein the timer activates when the one or more triggering conditions is satisfied, and the BSR is sent during the activation of the timer.
